(19) United States
(12) Patent Application Publication
(10) Pub. No.: US 2013/0008935 A1
(43) Pub. Date: Jan. 10, 2013

(54) FASTENER DETECTION

(75) Inventors: Steven Brusaw, Miamisburg, OH (US); Patrick Croskey, Dayton, OH (US); William Filbrandt, West Chester, OH (US); Thai Ho, Springboro, OH (US); Martin Luers, Lebanon, OH (US); Paul Settimo, Hamilton, OH (US)

(73) Assignee: ADVANCED ENGINEERING SOLUTIONS, INC., Springboro, OH (US)

(21) Appl. No.: 13/542,762

(22) Filed: Jul. 6, 2012

Related U.S. Application Data
(60) Provisional application No. 61/505,490, filed on Jul. 7, 2011.

(51) Int. Cl. B27F 7/19; B25C 5/02

(52) U.S. Cl. 227/4; 227/155

(57) ABSTRACT

A fastener detection system detects a fastener striking an anvil. The fastener detection system comprises a first anvil section having a first conductive work surface that receives a first leg of the fastener during a fastening operation, and a second anvil section having a second conductive work surface that receives a second leg of the fastener during the fastening operation. The second conductive work surface is electrically isolated from the first conductive work surface of the first anvil section. A first conductor electrically couples the first conductive work surface to a detection circuit, and a second conductor electrically couples the second conductive work surface to the detection circuit. The detection circuit identifies that the fastening operation has occurred by electrically sensing continuity between the first conductive work surface of the first anvil section and the second conductive work surface of the second anvil section.

### CROSS REFERENCE TO RELATED APPLICATIONS

This application claims the benefit of U.S. Provisional Patent Application Ser. No. 61/505,490, filed Jul. 7, 2011 entitled “FASTENER DETECTION”, the disclosure of which is hereby incorporated by reference.

### BACKGROUND

Various aspects of the present invention relate generally to fastening operations and more specifically to detecting that a fastener struck a corresponding anvil during a fastening operation.

Many fastening operations are performed by staplers, which drive a staple, through articles to be attached together. A staple is a two-pronged fastener comprised of a pair of legs that are spaced apart by a crown. The end portions of the staple legs can include teeth, points or other features that allow the staple to penetrate through the articles to be attached together. The crown can be used to span articles butted together, e.g., for joining operations, or the crown can serve as a securement, e.g., for binding operations where articles are held together by pinching articles between the crown and folded legs of a staple.

To ensure a positive attachment, the articles to be attached together are positioned between a driving element of the stapler and an anvil. Upon actuation of the stapler, the driving element pushes a staple through the articles to be attached. However, the crown of the staple does not penetrate the articles. Rather, towards the end of a stapling cycle, the legs of the staple, which have now penetrated the articles to be fastened, strike the anvil. As the legs strike the anvil, the legs bend and are clinched or are otherwise folded back against the bottom most article, thus securing the articles together between the crown and legs.

### BRIEF SUMMARY

According to aspects of the present invention, a fastener detection system is provided, which detects a fastening operation. The fastener detection system comprises in general, an anvil coupled to a detection circuit. More particularly, the anvil comprises a first anvil section having a first conductive work surface that receives a first leg of a fastener during a fastening operation. Analogously, the anvil comprises a second anvil section having a second conductive work surface that receives a second leg of the fastener during the fastening operation. The second conductive work surface is electrically isolated from the first conductive work surface of the first anvil section. A first conductor electrically couples the first conductive work surface to the detection circuit. A second conductor may also be provided to electrically couple the second conductive work surface to the detection circuit. The detection circuit identifies that the fastening operation has occurred by electrically sensing continuity between the first conductive work surface of the first anvil section and the second conductive work surface of the second anvil section.

According to further aspects of the present invention, a method is provided for detecting a fastening operation. The method comprises providing a first anvil section having a first conductive work surface that receives a first leg of a fastener during a fastening operation, and providing a second anvil section having a second conductive work surface that receives a second leg of the fastener during the fastening operation, where the second conductive work surface is electrically isolated from the first conductive work surface of the first anvil section. The method further comprises detecting continuity between the first conductive work surface and the second conductive work surface and identifying a fastening operation when continuity is detected.

In an illustrative implementation, detecting continuity is performed by coupling a first conductor between the first conductive work surface and a detection circuit, coupling a second conductor between the second conductive work surface and the detection circuit, and identifying by the detection circuit, that the fastening operation has occurred by electrically sensing continuity between the first conductive work surface of the first anvil section and the second conductive work surface of the second anvil section.

According to still further aspects of the present invention, a fastener detection system is provided, which detects a fastening operation. The system comprises a first anvil section having a first conductive work surface that receives a fastener during a fastening operation, a detection circuit, and a first conductor that electrically couples the first conductive work surface to the detection circuit. The detection circuit identifies that the fastening operation has occurred by electrically sensing continuity between the first conductive work surface of the first anvil section and a corresponding tool that drives the fastener into the first conductive work surface of the first anvil section.

### BRIEF DESCRIPTION OF THE SEVERAL VIEWS OF THE DRAWINGS

FIG. 1 is a schematic illustration of a fastener detection system comprising an anvil and a detection circuit, according to various aspects of the present invention;

FIG. 2 is a block diagram of an exemplary detection circuit for a fastener detection system, according to aspects of the present invention;

FIG. 3A is a schematic of an exemplary detection circuit implemented according to the block diagram of FIG. 2;

FIG. 3B is a schematic of another exemplary detection circuit implemented according to the block diagram of FIG. 2;

FIG. 4 is an illustration of an exemplary anvil for use with a fastener detection system, according to various aspects of the present invention;

FIG. 5 is an illustration of another view of the exemplary anvil of FIG. 4;

FIG. 6 is a schematic illustration of an exemplary stapler and corresponding anvil within a fastener detection system, according to various aspects of the present invention;

FIG. 7 is another view of the stapler and anvil of FIG. 6; and

FIG. 8 is an alternative implementation of a fastener detection system according to further aspects of the present invention.

For simplicity and clarity of illustration, elements shown in the figures have not necessarily been drawn to scale. For example, the dimensions of some of the elements may be exaggerated relative to other elements for clarity of discussion.

### DETAILED DESCRIPTION

According to various aspects of the present invention, systems and methods are provided for detecting when an intended fastening operation has occurred. The fastening operation may result, for instance, in the clinching of the legs of a fastener, thus securing the fastener to a work piece.

As will be described in greater detail herein, a fastener detection system comprises a split anvil coupled to a detection circuit. The split anvil includes a first anvil section that is electrically isolated from a second anvil section. As will be described in greater detail herein, the first anvil section includes a first conductive work surface that receives a first leg of a fastener during a fastening operation. Analogously, the second anvil section includes a second conductive work surface that receives a second leg of the fastener during the fastening operation. A first conductor electrically couples the first conductive work surface to the detection circuit. Likewise, a second conductor electrically couples the second conductive work surface to the detection circuit.

In operation, the detection circuit identifies that a fastening operation has occurred by electrically sensing continuity between the first conductive work surface of the first anvil section and the second conductive work surface of the second anvil section.

In general, the split anvil and the detection circuit can be utilized to identify the presence or absence of a fastener. For instance, in a non-limiting but illustrative example, a system controller can detect that a tool, e.g., a stapler, is empty, has jammed, misfired, etc., by detecting that the tool has been actuated, but that no corresponding staple was detected by the detection system. As another illustrative example, an assumption can be drawn that a staple has been clinched by detecting that the staple has been driven into the anvil. Additional details are described in greater detail herein.

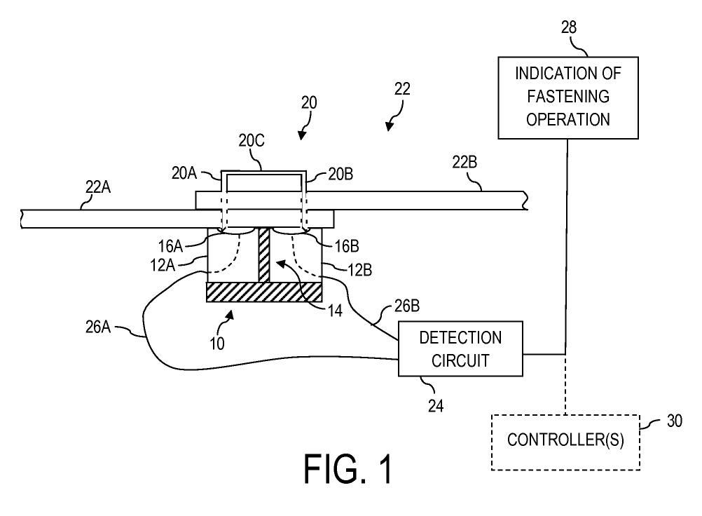

Referring now to the drawings and in particular, to FIG. 1, an anvil 10 is comprised of a first anvil section 12A and a second anvil section 12B, which are spaced apart from one another by an insulator 14. The first anvil section 12A has a first conductive work surface 16A. Correspondingly, the second anvil section 12B has a second conductive work surface 16B. As such, the first conductive work surface 16A is electrically isolated via the insulator 14, from the second conductive work surface 16B, in a normal (steady) state. The anvil 10 is utilized in fastening operations. For example, as illustrated, the anvil 10 is utilized as a stop when driving a fastener such as a staple 20 through a work piece 22.

The illustrated staple 20 includes a first leg 20A and a second leg 20B, which are separated by a crown 20C. The lower portion of the first leg 20A and the second leg 20B can each optionally include a jag, tooth, point, tip or other structure that assists the staple 20 in driving through the work piece 20. Moreover, the first leg 20A, second leg 20B and crown 20C are constructed of a suitable material that provides a conductive pathway through the fastener 20.

For sake of illustration, the work piece 22 is shown as a first component 22A and a second component 22B. However, in practice, the work piece 22 can comprise any number of suitable work piece components as typically dictated by the particular application. For instance, in the stapling of relatively heavy work piece components, such as carpet, there may be only two pieces. However, when stapling thin components, e.g., paper, there may be a few to several hundred sheets stacked together for fastening. The first component 22A and second component 22B of the work piece 22 are illustrated as partially overlapping for purposes of discussion only. The first component 22A and second component 22B of the work piece 22 can alternatively be stacked, butted together end-to-end, or otherwise arranged.

When the fastener, e.g., the staple 20 as illustrated, is driven by a suitable tool, e.g., a pneumatic stapler, electric stapler, manual stapler or other suitable driving device (not shown in FIG. 1), the first leg 20A and the second leg 20B of the staple 20 each pierce the work piece 22, engage the anvil 10, and are bent (clinched).

In the illustrative implementation, the first anvil section 12A and the second anvil section 12B comprise components of a split anvil 10 having an insulator 14, e.g., a non-conductive material (or an alternative such as an air gap), that spaces the first anvil section 12A from the second anvil section 12B. The first conductive work surface 16A of the first anvil section 12A comprises a generally curved portion. When a staple 20 is driven into the anvil 10, the curved portion of the first anvil section 12A makes contact with an end portion of the first leg 20A of the staple 20. As the staple 20 is driven into the anvil 10, the curved portion of the first anvil section 12A bends the end portion of the first leg 20A.

Analogously, the second conductive work surface 16B of the second anvil section 12B also comprises a generally curved portion. When the staple 20 is driven into the anvil 10, the curved portion of the second anvil section 12B makes contact with an end portion of the second leg 20B of the staple 20. As the staple 20 is driven into the anvil 10, the curved portion of the second anvil section 12B bends the end portion of the second leg 20B.

As such, electrical continuity is temporarily formed between the first anvil section 12A and the second anvil section 12B (or at least the first and second conductive work surfaces 16A and 16B) via the conductive fastener 20 while the anvil 10 is clinching the fastener 20 during the fastening operation. Although the first and second conductive work surfaces 16A and 16B are curved for purposes of clarity of discussion herein, aspects of the invention are not limited to such. Rather, the surfaces may be flat or take on other contours appropriate for a particular fastening application.

For instance, in an illustrative implementation, the first anvil section 12A is made from a hard material, such as metal. As illustrated, the first conductive work surface 16A of the first anvil section 12A is generally concave thus defining a first well having a contour that extends generally along a lateral axis that is substantially parallel to the crown 20C of a staple 20 intended to be driven into the anvil 10. Analogously, the second anvil section 12B is also made from a hard material, such as metal. As illustrated, the second conductive work surface 16B of the second anvil section 12B is also generally concave thus defining a second well having a contour that extends generally along a lateral axis that is substantially parallel to the crown 20C of the staple 20 intended to be driven into the anvil 10.

The first conductive work surface 16A receives the first leg 20A of the fastener 20 during a fastening operation. As the tip of the first leg 20A strikes the first conductive work surface 16A, the end portion of the first leg 20A enters into the first well which causes the first leg 20A to begin to bend or otherwise curl inward towards the center of the staple 20. Analogously, the second conductive work surface 16B receives the second leg 20B of the fastener 20 during the fastening operation. As the tip of the second leg 20B strikes the second conductive work surface 16B, the end portion of the second leg 20B, enters into the second well which causes the second leg 20B to begin to bend or otherwise curl inwards towards the center of the staple 20. The specific radius of curvature of the first well and the second well can be varied to achieve the proper initial bending and curling of the first leg 20A and second leg 20B, respectively.

Although the legs 20A, 20B are bent inward as described herein, other fastening operations may alternatively be performed. For instance, the legs 20A, 20B, shape of the crown 20C, configuration of the anvil 10 and other factors may be manipulated in other fashions, e.g., to curl the legs 20A, 20B outward relative to each other, or to bend the legs 20A, 20B into other configurations as required by a particular fastening operation.

In practice, there are a number of situations that can arise where an intended fastening operation results in an unclinched fastener. As a few non-limiting but illustrative examples, the tool can jam or run out of fasteners. Likewise, a fastener may not entirely penetrate the work piece 22 or the fastener may strike the anvil 10 with insufficient force to cause the fastening (e.g., clinching) operation to be performed. This can occur for a number of reasons. For instance, if the tool is pneumatic, there may be insufficient air pressure to cause the fastener 20 to be driven with sufficient force to cause the fastening operation to be performed. As another example, the tool, such as a manual, electric, pneumatic, etc., stapler may not have exerted enough pressure against the work piece 22 and anvil 10 to cause the fastener to be clinched.

However, according to aspects of the present invention, a fastener detection system is provided that detects the presence of a fastener striking the anvil 10. Thus, for example, based upon the detection of a fastener 20 such as a staple, it can be assumed that a clinching operation is performed. In this regard, a detection circuit 24 is provided to detect success of fastening operations, failure of fastening operations or both success and failure of fastening operations.

As illustrated, a first conductor 26A electrically couples the first conductive work surface 16A of the first anvil section 12A to the detection circuit 24. Likewise, a second conductor 26B electrically couples the second conductive work surface 16B of the second anvil section 12B to the detection circuit 24. As illustrated, the first conductor 26A electrically couples to the first conductive work surface 16A through the first anvil section 12A. Likewise, the second conductor 26B electrically couples to the second conductive work surface 26B through the second conductive section 12B. Coupling can be direct or indirect. For instance, the second conductor 26B may couple the second conductive work surface 16B to a fixed reference potential, such as ground, which is utilized by the detection circuit 24.

The detection circuit 24 identifies that the fastening operation has occurred by electrically sensing continuity between the first conductive work surface 16A of the first anvil section 12A and the second conductive work surface 16B of the second anvil section 12B. Continuity is caused, for instance, by the ends of the legs and crown of a fastener, such as a staple, electrically bridging the first conductive work surface 16A to the second conductive work surface 16B. In this regard, as illustrated in the exemplary implementation, the staple 20 electrically couples the first conductive work surface 16A to the second conductive work surface 16B when the staple 20 is driven into the anvil 10.

Some fasteners, such as staples, include glue, adhesive and/or other coatings that are used to assemble a plurality of staples into a format that can be fed into a magazine of the tool. However, according to aspects of the present invention, accurate identification of the fastening operation is detected despite any such coatings on a fastener 20 being driven. For instance, the force of the fastener 20 driving into the anvil 10, e.g., the force of the end portion of each leg of the staple being driven to the point of bending or otherwise curling in a corresponding well of the anvil 10 in the illustrated figure, is sufficient to break any coatings and create an electrical connection between the first conductive work surface 16A of the first anvil section 12A and the second conductive work surface 16B of the second anvil section 12B.

The results determined by the detection circuit 24 are optionally fed to an output device 28. The output device 28 can provide audible or visual indications as to the success (or failure) of the fastening operation. Likewise, the output of the detection circuit 24 and/or the output device 28 can provide feedback or other inputs to machine logic to drive further workflows as schematically illustrated by the connection to external controller(s) 30. For instance, the output may be statistical data that is utilized by another process or controller for either subsequent data analysis or to control some downstream process or workflow.

As another example, in a machine fixture, the detection of a proper fastening operation can drive a workflow to release the work piece(s) 22 being fastened. Similarly, if no fastening operation is detected, the workflow can refuse to unlock or otherwise release the work piece 22 until the fastening operation is successfully detected. In this regard, the output device 28 can be integrated into the detection circuit 24, or the output device 28 may be a separate component, circuitry, software or other logic that is coupled to the detection circuit 24. As such, the detection circuit 24 can be configured to capture, save, process, modify or otherwise manipulate a signal indicative of whether a fastener has contacted the anvil 10. The detection circuit 24 can process the signal locally. Moreover, the processed signal can be communicated to an external device, e.g., a programmable logic controller or other processor for further processing, analysis, logic, etc.

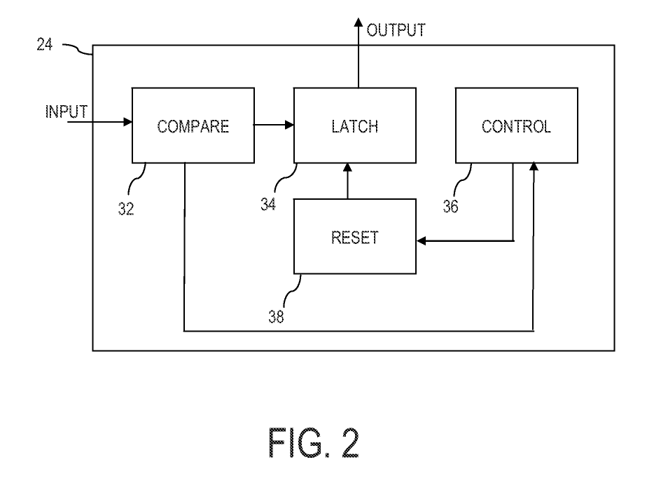

Referring to FIG. 2, a block diagram of an exemplary detection circuit 24 is illustrated according to illustrative aspects of the present invention. The detection circuit 24 is comprised of several logical circuits including a compare circuit 32, a latch circuit 34, a control circuit 36 and a reset circuit 38.

In an exemplary implementation, the compare circuit 32 comprises comparison circuitry that compares a first reference input to a second reference input. The first reference input may be coupled to the first conductor 26A and the second reference input may be coupled to the second conductor 26B. Alternatively, the second reference input can be coupled to a fixed reference, e.g., ground or some predetermined potential. Under this later configuration, the first conductor 26A is coupled to the first reference and the second conductor 26B is coupled to the fixed reference (and is thus also indirectly coupled to the detection circuit 24).

As yet another illustrative example, the first reference is tied to a first reference voltage and to the first conductor 26A. The second reference is tied to a second reference voltage different from the first reference voltage (e.g., lower in voltage). The second conductor 26B is tied to a third reference voltage that is different from the first and second reference voltages (e.g., ground). In this exemplary implementation, the second conductor 26B functions as a pull down to pull the first reference voltage below the second reference voltage during a fastening operation.

It is likely that the fastener 20 will only be in contact with the anvil 10 for a relatively short amount of time. Moreover, the signal used to sense the fastener striking the anvil 10 may be relatively small in intensity value. As such, the compare circuit 32 is configured to sense a change across the split anvil sections, e.g., to sense a small amplitude, short duration signal that is indicative of a fastener striking the anvil. Measuring a voltage, current, resistance, inductance, capacitance or other measurable parameter can provide the stimulus for detection. Alternatively, the stimulus for detection may be derived from one or more measurable parameters such as a parameter change over time, a measure of force, strain, etc. The comparison circuitry further provides a detection output that is indicative of whether a fastening operation has occurred based upon the comparison.

The latch circuit 34 comprises temporary storage circuitry that stores an indication of whether a fastening operation has occurred, where the indication is based upon the detection output of the compare circuit 32. Further, the reset circuit 38 comprises circuitry that clears (resets) the temporary storage circuitry of the latch circuit 34 based upon at least one predetermined condition.

For instance, an input is fed into the compare circuit 32. By way of example, the input may be a signal from the first conductor 26A and/or the second conductor 26B of the anvil 10, as illustrated in FIG. 1. The compare circuit 32 monitors the input in order to detect the fastening operation has occurred with respect to the anvil 10. When the compare circuit 32 detects a fastening operation, a signal (or alternatively, a state change of a signal) is sent to the latch circuit 34, which triggers the latch circuit 34 to derive an output signal indicative of the fastening operation being successfully detected. The compare circuit 32 also sends a signal to the control circuit 36. The control circuit 36 includes logic that processes the signal received from the compare circuit 32. On a predetermined condition, e.g., a triggering an event such as a predetermined passage of time, receipt of a confirmation signal from another process, etc., the control circuit 36 instructs the reset circuit 38 to clear the latch circuit 34. When the latch circuit 34 is reset, the detection circuit 24 is again ready to detect another fastening operation.

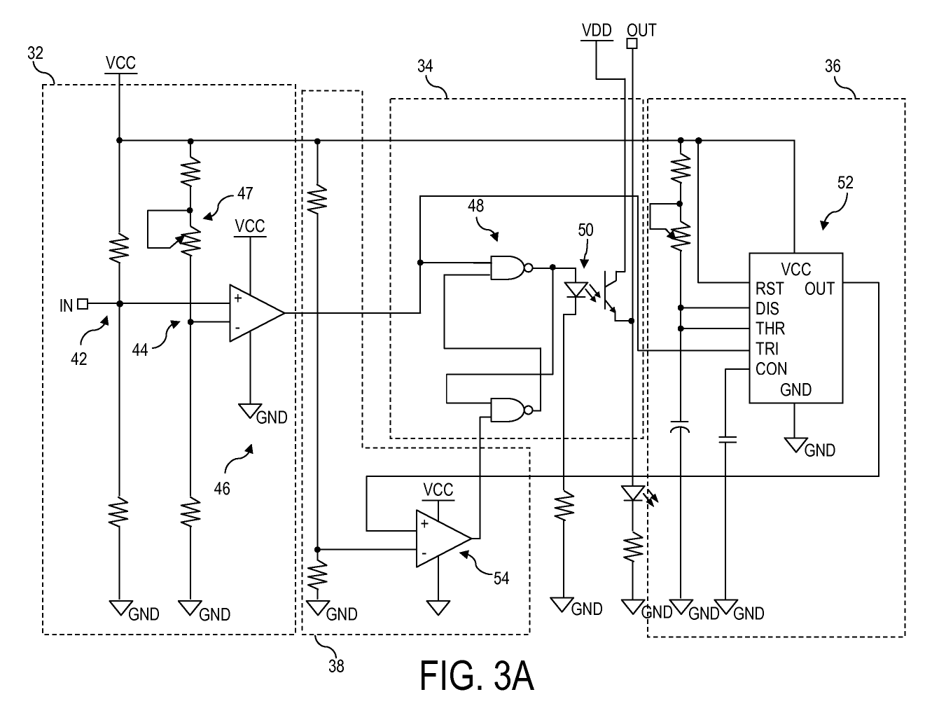

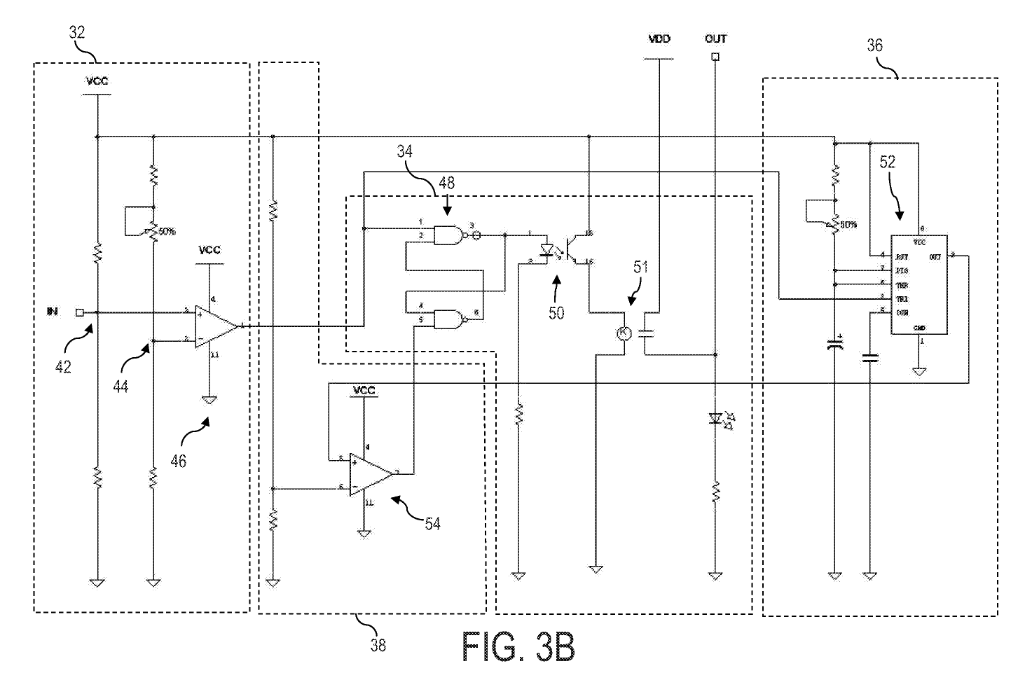

Referring to FIG. 3A, an exemplary schematic illustrates a circuit for implementing the detection circuit 24, according to various aspects of the present invention. The input enters the compare circuit 32. The compare circuit 32 is comprised of a first reference 42, a second reference 44 and a comparator 46. The comparator 46 compares the first reference 42 to the second reference 44.

As illustrated, the first reference 42 is implemented as a voltage divider of resistors between a rail voltage VCC and ground. As a non-limiting but illustrative example, the first conductor 26A of the anvil 10 is coupled to the first reference 42. The second conductor 26B is referenced to ground. Under steady state (no fastener engaging the anvil 10) conditions, the voltage divider raises the potential of the first conductive work surface 16A to the first reference 42. The second conductive work surface 16B is held at a potential of ground. Because of the insulator between the first anvil section 12A and the second anvil section 12B, there is an open circuit between the first conductive work surface 16A and the second conductive work surface 16B.

However, a fastening operation creates a temporary electrical connection between the first conductive work surface 16A and second conductive work surface 16B of the anvil 10. Thus, the first conductive work surface 16A and the second conductive work surface 16B effectively function as switch contacts that are temporarily closed by a fastener. Moreover, as noted more fully herein, the first conductive work surface 16A is electrically coupled to the first reference 42 via the first conductor 26A and the second conductive work surface 16B is electrically coupled to ground via the second conductor 26B. As such, when a fastener strikes the anvil 10, the voltage of the first reference 42 is pulled towards ground through a series circuit formed by the first conductor 26A, the fastener electrically coupled between the first conductive work surface 16A and the second conductive work surface 16B of the anvil 10, and the second conductor 26B, which is referenced to ground.

The second reference 44 may also be implemented as a voltage divider, e.g., series resistors between rail voltage VCC and ground. In general, the second reference 44 functions as a fixed reference point for comparison against the states of the first reference 42. The second reference 44 should be biased somewhere between the value of the first reference 42 when no fastening operation is being performed (its open state voltage) and the value of the first reference 42 when a fastener strikes the anvil 10 (its closed state voltage).

Moreover, the comparison circuitry optionally comprises a calibration control to adjust at least one of the first reference 42 and the second reference 44 to adjust the sensitivity of the comparison circuitry for a particular fastening environment. The calibration control effectively alters the difference between the first reference 42 and the second reference 44.

For instance, in the illustrative implementation, the second reference 44 includes programmability implemented by a trim potentiometer 47, which can be used to adjust the sensitivity of the comparator operation, e.g., to account for noise and other operating conditions. As further exemplary illustrations, the sensitivity of the comparison circuitry can be adjusted to account for environmental conditions such as the work piece, tool fixtures or other components of the system being damp or wet. As yet additional examples, the work piece may be damp or wet due to previous water jet cutting or other previous processing. Still further, the work piece may be frozen or in some other state that might require an adjustment to the sensitivity of the comparison circuitry to provide suitable processing.

In an illustrative implementation, the first reference 42 is configured to have a higher voltage than the second reference 44 when no fastening operation is being performed (first reference open state voltage). Because the first reference 42 couples to the non-inverting input of the comparator 46 and the second reference 44 couples to the inverting input of the comparator 46, the output of the comparator 46 is normally high. However, when a fastening operation is detected, the first reference 42 is pulled low (to ground) as described above. Under this arrangement, the first reference 42 at the non-inverting input of the comparator 46 is lower in voltage than the second reference 44 at the inverting input of the comparator 46. As such, the output of the comparator 46 is temporarily low while the fastener makes electrical contact between the first anvil section 12A and the second anvil section 12B. Thus, the output of the comparator 46 functions as a detection output that is indicative of whether a fastening operation has occurred based upon the comparison of the first reference 42 to a second reference 44.

The latch circuit 34 defines temporary storage circuitry and comprises a latch that holds the value of a signal that indicates that a fastening operation has been successfully performed. Thus, when the comparator 46 goes low, the latch circuit 34 changes state and outputs a signal indicating that a fastening operation has been detected.

By way of illustration and not by way of limitation, the latch circuit 34 is illustrated as a one-bit set/reset latch 48. To clearly illustrate the function implemented, the set/reset latch 48 is further illustrated as a pair of cross coupled two-input NAND gates that form a reset bistable latch. The two inputs comprise a “set” input coupled to the output of the comparator 46, and a “reset” input coupled to the reset circuit 38. The output of the latch 48 drives an optocoupler 50, e.g., a phototransistor optically coupled to an infrared-emitting diode, to provide isolation between the output of the latch 48 and the output of the detection circuit 24. This may be useful, for instance, to level shift to a different rail voltage, e.g., to shift from a working voltage of VCC to a higher (or lower) working voltage VDD. In practice however, the latch circuit 34, if necessary, can be implemented in any logic (including software), which is suitably configured to persist the indication of a successful fastening operation for sufficient duration to enable subsequent workflows.

Further, other and/or additional devices may be used in the circuitry to achieve a desired output. Referring briefly to FIG. 3B, a schematic of a detection circuit is illustrated which is analogous to the detection circuit of FIG. 3A. However, the circuit of 3B includes a modification to the latch circuit 34 to include a relay 51. For instance, where a relatively high voltage or high current output signal is required, relays and other appropriate devices may be utilized.

Referring back to FIG. 3A, the compare circuit 32 also provides input to the control circuit 36. The control circuit 36 sends a signal to the reset circuit 38 at appropriate timing to reset the latch 48 of the latch circuit 34. The control circuit 36 can be implemented in a desired logic, which will be determined by the particular application. For instance, in an illustrative implementation, the control circuit 36 comprises a timer 52 that controls when the reset circuitry clears the temporary storage circuitry in response to detecting a fastening operation.

As an illustration, and not by way of limitation, the control circuit 36 is implemented as a timer 52. For instance, a 555 timer is configured as a monostable circuit that produces a single output pulse when triggered by the compare circuit 32. The output of the timer 52, which is coupled to the reset circuit 38, is normally low. When the compare circuit 32 triggers the timer 52, the timer 52 outputs a temporary high pulse. A resistor-capacitor circuit coupled to the timer determines the duration of the high pulse. As illustrated, the resistor/capacitor circuit includes a trim potentiometer to provide adjustability to the duration of the high output state. However, such user adjustability is not necessary.

The reset circuit 38, as illustrated in the simplified schematic, includes a comparator 54. A third, fixed reference voltage is coupled to the inverting input of the comparator 54. The non-inverting input is coupled to the output of the timer 52, which is normally low. This keeps the output of the comparator 54 normally low, thus keeping the latch 48 in a “latch-ready” state by holding the “reset” input of the latch 48 low. However, when the comparator 46 outputs a low pulse in response to the detection of a fastening operation, the timer 52 triggers and begins to output a high pulse, thus driving the comparator 54 high. As long as the timer 52 remains in a high state, the output of the latch circuit 34 remains latched. At the end of the duration of the timer operation, the output of the timer 52 transitions to a low state. This causes the comparator 54 of the reset circuit 38 to drop low, causing the latch 48 to reset. As a result, the latch 48 of the latch circuit 34 is reset to a default state.

Although described in simple terms in order to demonstrate the principle of operation, the control circuitry 36 can include more sophisticated processing, e.g., using a microcontroller and program code, a microprocessor, or other suitable technology as the particular application dictates.

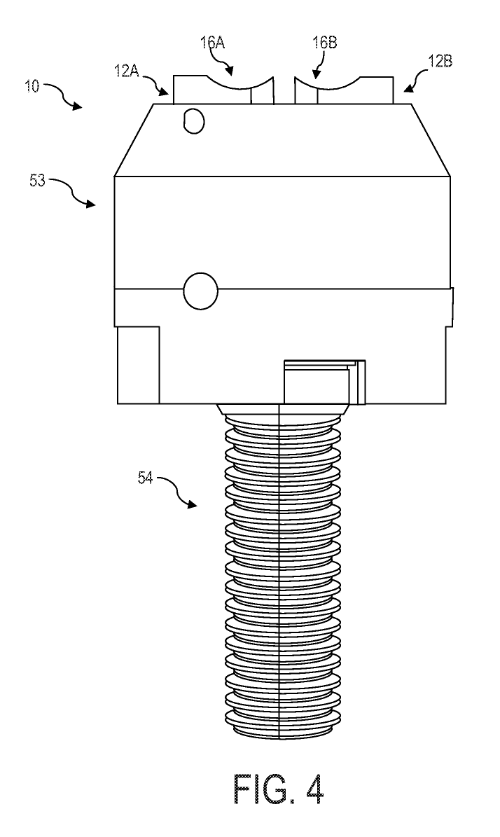

Referring to FIG. 4, an exemplary anvil 10 is illustrated, which is adapted for use in a jig, fixture or other part of a machine to interface with an industrial fastening device, e.g., a pneumatic stapler, as will be described in greater detail below. The anvil 10 is substantially analogous to the anvil described with reference to FIG. 1. However, the illustrated anvil 10 further comprises an anvil housing 53 that supports the first anvil section 12A and the second anvil section 12B. Moreover, the anvil housing 53 supports a coupler, e.g., a threaded member 54 that allows the anvil 10 to be installed in appropriate tooling.

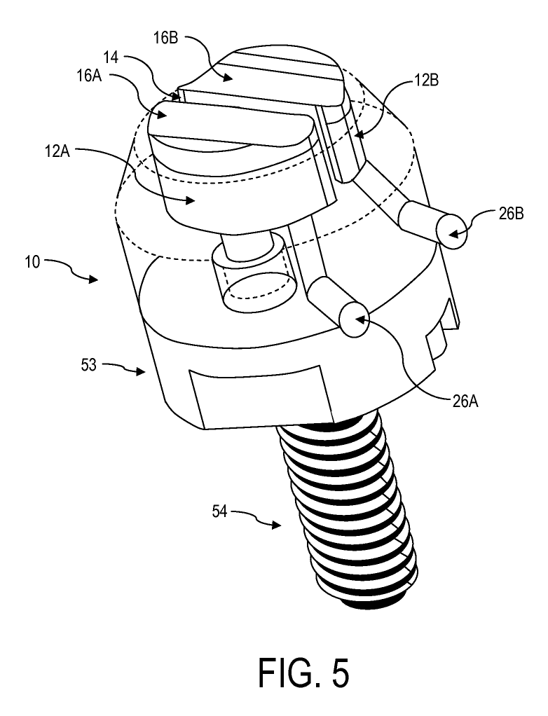

Referring to FIG. 5, the anvil 10 of FIG. 4 is illustrated in partial cutaway view to further illustrate the arrangement of the first conductor 26A coupled to the first conductive work surface 16A via the first anvil section 12A and the second conductor 26B coupled to the second conductive work surface 16B via the second anvil section 12B.

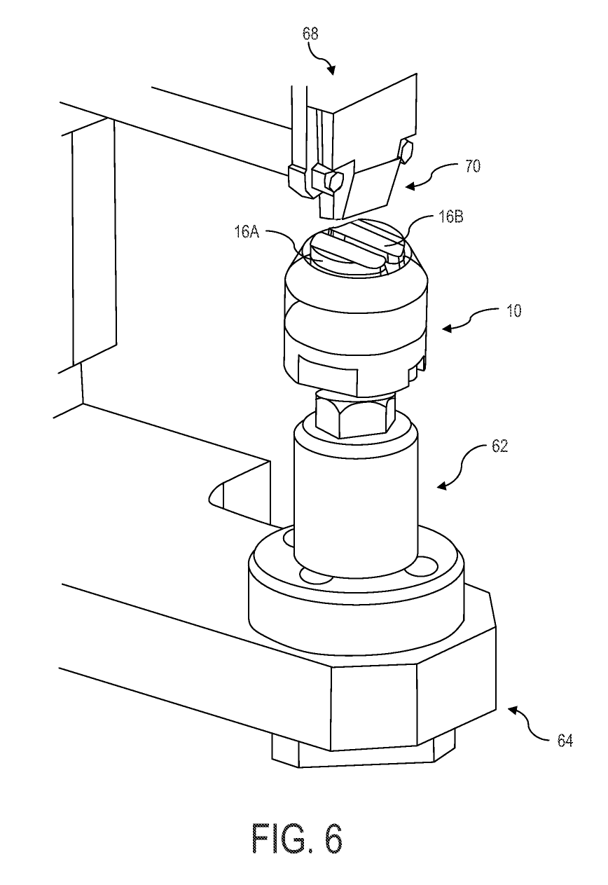

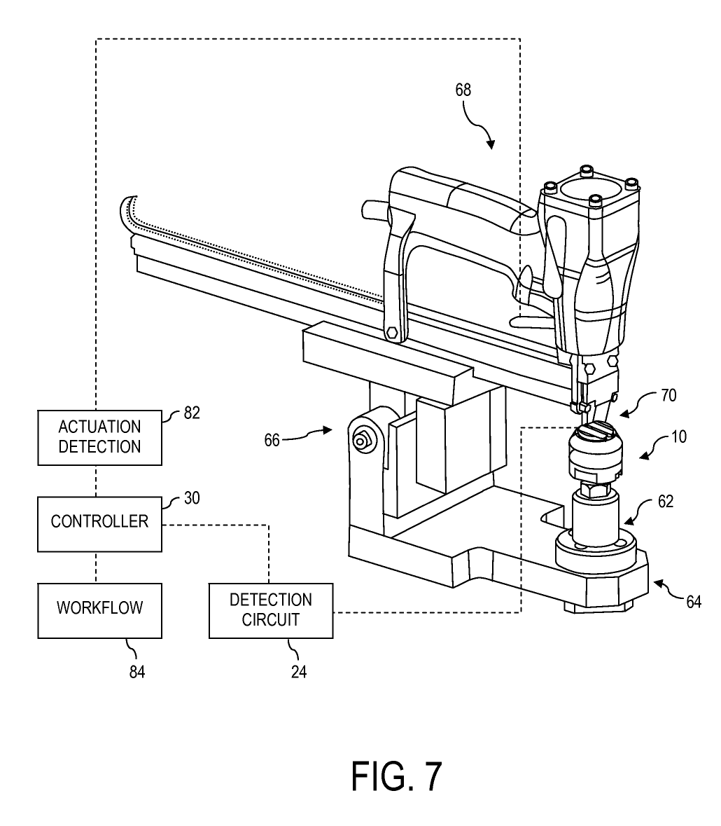

Referring to FIGS. 6 and 7, the anvil 10 is illustrated in an exemplary implementation for use with a pneumatic stapler. As illustrated, the anvil 10 is secured to a holder 62. For instance, the threaded member 54 of the anvil 10 can be screwed into a complementary member of the holder 62. Other securing arrangements can alternatively be used. The holder 62 couples to a tooling fixture 64, which includes a hinged portion 66 that couples to a mounted pneumatic stapler 68. The hinged portion 66 allows the stapler 68 to be pivotally rotated in and out of cooperation with the anvil 10. As illustrated, the anvil 10 aligns with the nose 70 of the stapler 68 such that, upon actuation of the stapler 68, a first leg of a staple is driven into the first conductive work surface 16A of the anvil 10, and a second leg of the staple is driven into the second conductive work surface 16B of the anvil 10. Under this configuration, a work piece 22 to be fastened can be easily positioned between the nose 70 of the stapler 68 and the anvil 10. The anvil 10 is further coupled to the detection circuit 24 (not shown in FIG. 6 for purposes of clarity).

The stapler and anvil of FIGS. 6 and 7 can be integrated into an automated, semi-automated or manually operated machine in a manner capable of detecting a fastening operation, or alternatively, to detect the failure of a fastening operation. Referring specifically to FIG. 7, an actuation detection circuit 82 detects actuation of the tool, e.g., stapler 68. The particular implementation of the actuation detection circuit 82 will vary depending upon the type of tool. For instance, the actuation detection circuit 82 can detect an electrical signal representing the closing of a valve in a pneumatic tool, the pulling of the trigger, or when the tool is otherwise actuated. As another example, the actuation detection circuit 82 can detect the state of a contact switch used to sense the closing of the trigger of the tool. Other techniques can alternatively be used. As noted above, the anvil 10 can also be coupled to a detection circuit 24, which is analogous to the detection circuit described more fully herein. The detection circuit 24 and the actuation detection circuit are coupled to a controller 30. The controller 30 is also analogous to the controller 30 described in greater details herein.

In an illustrative example, the controller 30 includes a programmable logic controller or system controller that detects when the trigger of the stapler is pulled or when the tool is otherwise actuated. Upon knowing that the tool should have been actuated, the system controller can read the output of the detection circuit 24, which indicates whether a fastener struck the anvil 10. If the detection circuit 24 indicates detection of a fastener, the operation may be assumed to be successful, e.g., a staple has been clinched. On the other hand, if the detection circuit 24 fails to identify the detection of a fastener striking the anvil 10 shortly after actuation of the tool, then an assumption can be drawn that the tool is out of fasteners, is jammed or otherwise malfunctioned. As such, a warning, workflow 84, e.g., an action can be taken to alert a machine operator of the problem. Other workflows can alternatively be implemented. Moreover, additional processes may alternatively be implemented. For instance, counters and other measures of performance or use can be updated, etc.

Referring to the Figures generally, although the detection circuit 24 was described with reference to FIG. 3 as sensing a change in a reference voltage relative to ground, aspects of the present invention are not limited thereto. For instance, the first and second conductors 26A, 26B can be used as a differential signal that is coupled to the detection circuit 24.

Moreover, instead of detecting conduction or lack thereof between first and second anvil sections 12A, 12B, other alternative arrangements may be implemented. For instance, conductivity can be measured between the tool, fastener and anvil, where the fastener defines the temporary electrical coupling between the tool and the anvil 10. Here, the system is largely analogous to that set out with reference to FIGS. 1-7 except that, instead of referencing the second conductor 26B coupled to the second conductive surface 16B of the anvil 10 to ground, the driver inside the tool nose 70 is grounded or otherwise coupled to a potential. Thus, during a driving operation, the driver of the tool, the fastener and the anvil define a circuit, thus coupling the first reference 42 by the path from a conductive work surface 16 of the anvil, through the fastener 20, through the tool.

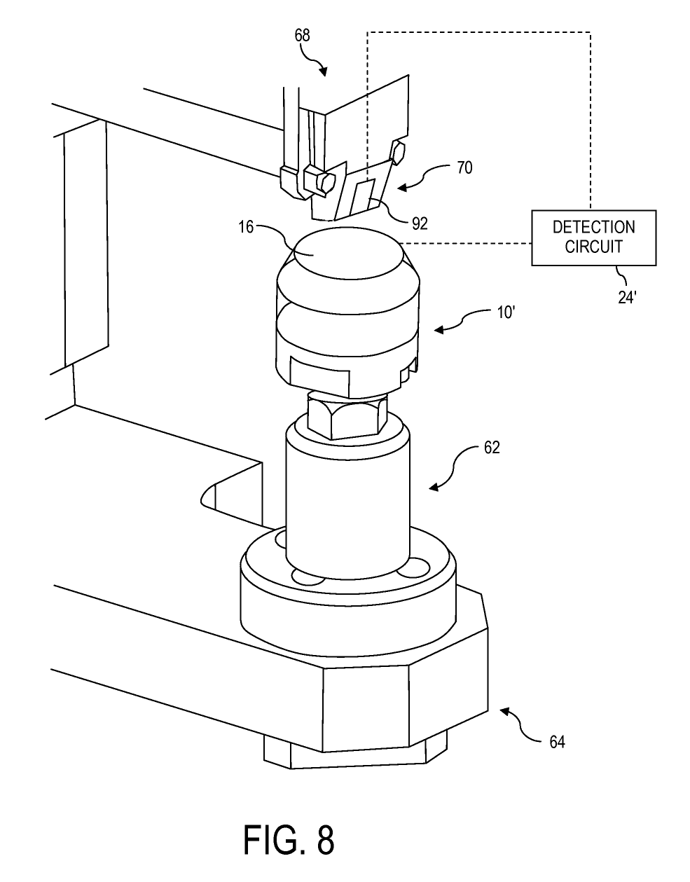

Referring to FIG. 8, the tool includes a driver 92 that is coupled to the detection circuit 24′, e.g., via a direct connection or via a connection to a fixed reference, such as ground. Because there is no need for a split anvil, the anvil 10′ is illustrated as having a single conductive work surface 16. The conductive work surface 16 is coupled to the detection circuit 24′ in a manner analogous to that described more fully herein with regard to detection circuit 24.

Thus, this exemplary alternative system comprises a first anvil section having a first conductive work surface that receives a fastener during a fastening operation, a detection circuit, and a first conductor that electrically couples the first conductive work surface to the detection circuit. The detection circuit identifies that the fastening operation has occurred by electrically sensing continuity between the first conductive work surface of the first anvil section of the anvil and a corresponding tool that drives a fastener into the first conductive anvil section. The system of FIG. 8 can use the controller(s) 30, actuation detection circuit 82, etc. in a manner analogous to that described more fully herein.

Still further, alternative methods may be implemented to measuring the fastening operation. For instance, other types of measurements may be implemented to detect a change between the first anvil section 12A and the second anvil section 12B, (or first anvil section 12A and a corresponding tool) which is indicative of a fastening operation.

Also, the spirit of the various embodiments of the present invention is not intended to be limited for use with a pneumatic stapler. Rather, any stapler or other tool capable of driving fasteners with one or more legs can be utilized in conjunction with the anvil configuration to detect a fastening operation. For instance, the fastener detection systems described more fully herein can be used with electrical staplers, e.g., in copy machines, pneumatic tools in industrial settings, on automated tooling fixtures, etc.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “having,” “has,” or any combination thereof when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

What is claimed is:

1. A fastener detection system, the system comprising:
an anvil having:
a first anvil section having a first conductive work surface that receives a first leg of a fastener during a fastening operation; and
a second anvil section having a second conductive work surface that receives a second leg of the fastener during the fastening operation, the second conductive work surface electrically isolated from the first conductive work surface of the first anvil section;
a detection circuit; and
a first conductor that electrically couples the first conductive work surface to the detection circuit;
wherein:
the detection circuit identifies that the fastening operation has occurred by electrically sensing continuity between the first conductive work surface of the first anvil section and the second conductive work surface of the second anvil section.

2. The fastener detection system according to claim 1, wherein:
the first anvil section and the second anvil section comprise a split anvil having an insulator that spaces the first anvil section from the second anvil section.

3. The fastener detection system according to claim 1, wherein:
the first conductive work surface of the first anvil section comprises a generally curved portion that makes contact with, and bends, an end portion of the first leg of a conductive fastener that is driven into the split anvil; and
the second conductive work surface of the second anvil section comprises a generally curved portion that makes contact with, and bends, an end portion of the second leg of the conductive fastener that is driven into the split anvil;
wherein electrical continuity is temporarily formed between the first anvil section and the second anvil section through the conductive fastener.

4. The fastener detection system according to claim 1, wherein:
the detection circuit comprises:
comparison circuitry that compares a first reference input to a second reference input and provides a detection output that is indicative of whether a fastening operation has occurred based upon the comparison, wherein the first conductor is coupled to the first reference input;
temporary storage circuitry that stores an indication of whether a fastening operation has occurred, wherein the indication is based upon the detection output; and
reset circuitry that clears the temporary storage circuitry based upon at least one predetermined condition.

5. The fastener detection system according to claim 4, wherein the comparison circuitry comprises:
a calibration control to adjust at least one of the first reference input and the second reference input to adjust the sensitivity of the comparison circuitry for a particular fastening environment.

6. The fastener detection system according to claim 4, wherein the temporary storage circuitry comprises a latch that holds the value of a signal that indicates that a fastening operation has been successfully performed.

7. The fastener detection system according to claim 4, further comprising a timer that controls when the reset circuitry clears the temporary storage circuitry in response to detecting a fastening operation.

8. The fastener detection system according to claim 1, wherein:
the detection circuit further comprises an output that provides at least one of an audible or visual indication of a status of a fastening operation.

9. The fastener detection system according to claim 1, further comprising:
an actuation detection circuit that detects the actuation of a tool that drives the fastener to be detected by the anvil; and
a controller that determines whether a fastening operation occurred based upon the detection of the actuation of the tool by the actuation detection circuit and by the identification that the fastening operation occurred by the detection circuit coupled to the anvil.

10. A method of detecting clinching of a fastener, the method comprising:
providing an anvil that includes a first anvil section having a first conductive work surface that receives a first leg of a fastener during a fastening operation;
providing a second anvil section having a second conductive work surface that receives a second leg of the fastener during the fastening operation, the second conductive work surface electrically isolated from the first conductive work surface of the first anvil section;
coupling a first conductor between the first conductive work surface and a detection circuit; and
identifying by the detection circuit, that the fastening operation has occurred by electrically sensing continuity between the first conductive work surface of the first anvil section and the second conductive work surface of the second anvil section.

11. The method according to claim 10, wherein:
providing a first anvil section and providing a second anvil section further comprises:
providing the first anvil section and the second anvil section as a split anvil having an insulator that spaces the first anvil section from the second anvil section.

12. The method according to claim 10, wherein identifying by the detection circuit, that the fastening operation has occurred by electrically sensing continuity, further comprises:
detecting electrical continuity as the first leg and the second leg of a conductive fastener strike the split anvil such that electrical continuity is temporarily formed between the first anvil section and the second anvil section through the conductive fastener.

13. The method according to claim 10, wherein:
identifying by the detection circuit, that the fastening operation has occurred, comprises:
comparing a first reference to a second reference and providing a detection output that is indicative of whether a fastening operation has occurred based upon the comparison, wherein the first conductor of the first anvil section is coupled to the first reference;
temporarily storing an indication of whether a fastening operation has occurred in temporary storage circuitry, wherein the indication is based upon the detection output; and
resetting the temporary storage circuitry based upon at least one predetermined condition.

14. The method according to claim 13, further comprising:
providing a calibration control to adjust at least one of the first reference and the second reference to accommodate a particular fastening environment.

15. The method according to claim 13, further comprising:
using a timer to determine when the to clear the temporary storage circuitry in response to detecting a fastening operation.

16. The method according to claim 10, further comprising:
providing at least one of an audible or visual indication of a status of a fastening operation.

17. The method according to claim 10, further comprising:
detecting the actuation of a tool that drives the fastener to be detected by the anvil; and
determining whether a fastening operation occurred based upon the detection of the actuation of the tool and by the identification that the fastening operation occurred by the detection circuit coupled to the anvil.

18. A fastener detection system that detects clinching of a fastener, the system comprising:
a first anvil section having a first conductive work surface that receives a fastener during a fastening operation;
a detection circuit; and
a first conductor that electrically couples the first conductive work surface to the detection circuit;
wherein:
the detection circuit identifies that the fastening operation has occurred by electrically sensing continuity between the first conductive work surface of the first anvil section and a corresponding tool that drives the fastener into the first conductive work surface of the first anvil section.

19. The fastener detection system of claim 18, further comprising:
a second conductor that couples a driver of the tool to the detection circuit;
wherein:
the detection circuit identifies that the fastening operation has occurred by electrically sensing continuity between the first conductor and the second conductor.

20. The fastener detection system of claim 18, further comprising:
an actuation detection control that detects actuation of the tool; wherein:
the detection circuit further identifies that a fastening operation has occurred based upon electrically sensing continuity between the first conductive work surface of the first anvil section and the corresponding tool after detecting actuation of the tool.
